(19) United States
(12) Patent Application Publication
(10) Pub. No.: US 2018/0121408 A1
(43) Pub. Date: May 3, 2018

(54) RENDERING TIME SERIES METRIC DATA ASSOCIATED WITH MULTI-DIMENSIONAL ELEMENT ID INFORMATION

(71) Applicant: CA, Inc., New York, NY (US)

(72) Inventors: Jason Robert Normandin, Marlborough, MA (US); Yang Yang, Newton, MA (US)

(21) Appl. No.: 15/339,575

(22) Filed: Oct. 31, 2016

(51) Int. Cl. G06F 17/24; G06F 17/30; G06T 11/20

(52) U.S. Cl. CPC G06F 17/245; G06F 17/30554; G06F 3/0482; G06T 11/206; G06F 17/30315

(57) ABSTRACT

Techniques for displaying time series metric data are disclosed herein. In some aspects, a management system generates time series metric data that include metric values associated with system entities and a timestamp associated with each of the metric values. A management system client displays the time series metric data in a first table object comprising multiple table entries that are each mapped to a respective one of multiple columnar fields and a respective one of multiple row records. The columnar fields include a system entity identifier (ID) field, a metric identifier field, and multiple timestamp value fields. In response to a first select signal received proximate to one or more of the row records, the management system client displays, within a first window object, time series metric data corresponding to one or more system entities that are each associated with a system entity ID specified by the system entity ID field of the selected one or more row records.

### BACKGROUND

The disclosure generally relates to the field of data processing, and more particularly to collecting, managing, and displaying data on a user interface.

Enterprise-level system monitoring and management require substantial processing, networking, and storage resources to support large scale collection of operational/performance data. Advanced management systems, such as systems that implement variations of Simple Network Management Protocol (SNMP), typically maintain target system infrastructure information and metric data associated with the components of the target system infrastructure. Substantial data management and formatting resources are required to collect and store the metric data in association with various hierarchical and grouping constructs.

Many formats are known for storing and presenting structured and unstructured data. Relational databases can be used to store structured data organized across tables and provide controlled accessed using a form of query language. For example, Structured Query Language (SQL) is frequently utilized for maintaining and querying many standard relational databases. The relational database model organizes data into two-dimensional tables (column/row) in which records (typically rows wise) are each indexed using a respective key. The row-wise entries may be ordered sets of data (e.g., tuples).

Presenting, such as on a computer display, system management data that is stored in relational databases may present issues relating to the time series nature of the metric data and the various organizational models, such as hierarchical relations and management groupings of the target system entities for which metric data is retrieved and displayed.

### BRIEF DESCRIPTION OF THE DRAWINGS

Aspects of the disclosure may be better understood by referencing the accompanying drawings.

FIG. 1 is a block diagram depicting a management service environment in accordance with some embodiments;

FIG. 2 is a block diagram illustrating a system architecture for rendering time series metric data in accordance with some embodiments;

FIG. 3 depicts display objects for rending time series metric data in accordance with some embodiments;

FIG. 4 is a flow diagram depicting operations and functions for generating and provisioning tabular data including table entries that are associated with multi-dimensional ID information in accordance with some embodiments;

FIG. 5 is a flow diagram illustrating operations and functions for rendering time series data associated with system entities having multi-dimensional entity ID information in accordance with some embodiments;

FIG. 6 illustrates display objects for rending time series metric data in accordance with some embodiments;

FIG. 7 depicts display objects for rendering time series metric data in accordance with some embodiments;

FIG. 8 is a flow diagram illustrating operations and functions for rendering time series data in accordance with some embodiments; and

FIG. 9 is a block diagram depicting an example computer system that renders time series metric data associated with multi-dimensional identity information in accordance with some embodiments.

### DESCRIPTION

The description that follows includes example systems, methods, techniques, and program flows that embody aspects of the disclosure. However, it is understood that this disclosure may be practiced without these specific details. In other instances, well-known instruction instances, protocols, structures and techniques have not been shown in detail in order not to obfuscate the description.

Overview

Embodiments described herein include components and implement operations for collecting, configuring, and displaying system management data. The system management data may be collected by a management service system (alternatively referred to as a “management system”) that includes service agents and a collection engine. A management system may be characterized as comprising software components that perform some type of utility function, such as performance monitoring and management, with respect to an underlying target system (referred to herein alternatively as a “target system” or a “system.” A target system may be characterized as a system configured, using any combination of coded software, firmware, and/or hardware, to perform user processing and/or network functions. For example, a target system may include a local area network (LAN) comprising network connectivity components such as routers and switches as well as end-nodes such as host and client computer devices. A management system may be deployed to execute operational support utility tasks such as performance monitoring, fault detection, and remediation functions. A management system typically employs operational/communication protocols distinct from those employed by the target system components. For example, many fault management systems may utilize some version of the Simple Network Management Protocol (SNMP).

In cooperation with service agents distributed throughout a target system (e.g., a network), the management system collection engine retrieves operational data such as time series metrics from system entities. The operational data may include time series metrics collected in accordance with collection profiles that are configured and updated by the management system. The collection profiles may be configured based, in part, on specified relations (e.g., parent-child) between the components (e.g., server-CPU) that are discovered by the management system itself. The collection profiles may also include service domain grouping of system entities that designate specified system entities as belonging to respective collection/service domains managed by corresponding management hosts. The data organization/formatting of the collection engine impacts the speed of assimilation and retrieval of queried system management records as well as network traffic between databases and requesting system management clients. For example, system management data may be frequently retrieved by one or more management clients for display on a display output device. Embodiments described herein include techniques for efficiently retrieving and displaying system management data including time series metric data.

The service domains are each configured in accordance with a respective management system instance to include one or more target system components. For example, the management system may be a distributed fault management system comprising multiple domains of specified target system components.

Example Illustrations

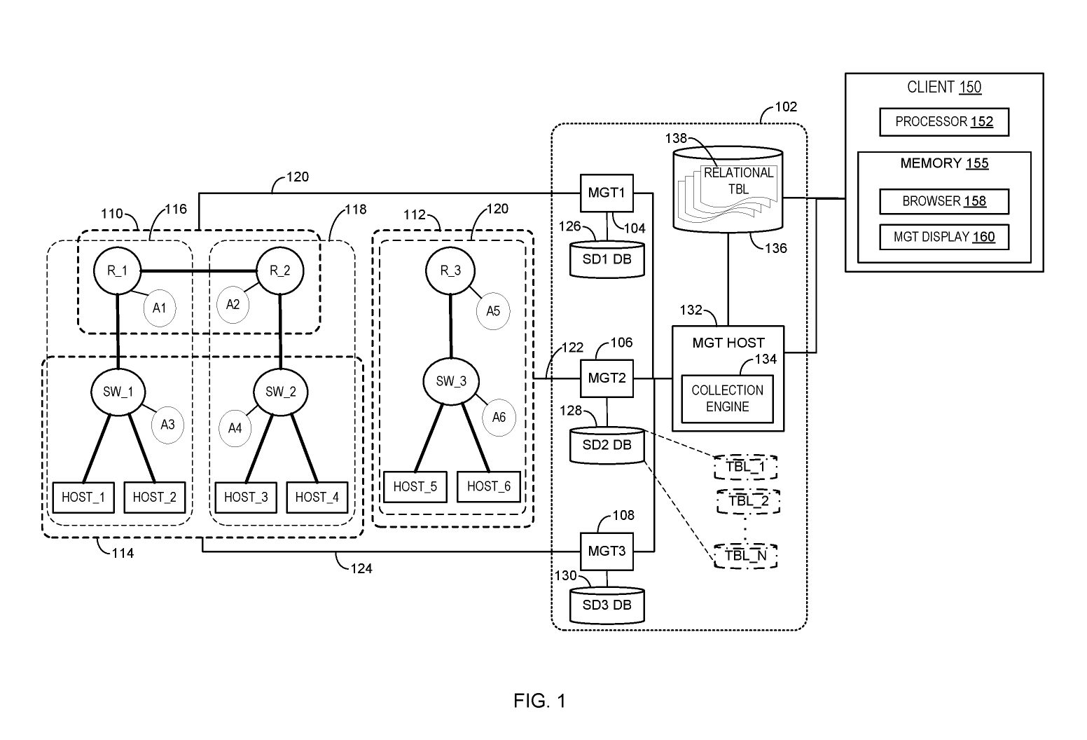

FIG. 1 is a block diagram depicting a management service environment in accordance with some embodiments. The management service environment includes a distributed management system 102 comprising management system (MS) instances 104, 106, and 108. As depicted and explained with reference to FIG. 1, the multiple MS instances of a distributed MS may be deployed from one or more computer platforms and are deployed by and otherwise coordinated by a central MS server, such as MS host server 132. MS instances 104, 106, and 108 execute applications that implement management functions such as monitoring and control of the managed, target system entities in each of respective service domains 110, 112, and 114.

MS host server 132 is configured, using any combination of coded software, firmware, and/or hardware, to deploy and coordinate MS instances 104, 106, and 108. For each of the MS instances, MS host server 123 determines service domains that each comprise and specify a set of target systems, subsystems, devices, and components to be monitored and otherwise managed by the corresponding MS instance. In the depicted embodiment, the MS instances 104, 106, and 108 are each configured to manage hardware and software systems, subsystems, devices, and components (individually and collectively referred to as “target system entities” or “system entities”) that are configured in a target system.

Management systems, such as distributed management system 102, are often deployed to monitor/manage very large computing and networking systems comprising vast numbers of hardware and software system entities. FIG. 1 illustrates a limited number of system elements to avoid obfuscating description of the principles of configuration and operation of the depicted embodiments. The depicted target system includes subnets 116, 118, and 120. Subnet 116 includes a router R_1, a switch SW_1, and a pair of end-nodes HOST_1 and HOST_2. Subnet 118 includes a router R_2, a switch SW_2, and a pair of end-nodes HOST_3 and HOST_4. Subnet 120 includes a router R_3, a switch SW_3, and a pair of end-nodes HOST_5 and HOST_6. Each of subnets 116, 118, and 120 are similarly configured as subnets by the use of common network address sub-field values. For example, the system entities/components may be configured within subnets 116, 118, and 120 by assignment of a common IP address prefix for each component within a given subnet.

The end-nodes HOST_1 through HOST_6 may be data processing platforms comprising any combination of software and/or hardware for transmitting, receiving, and processing data within and across their respective subnets. While not expressly depicted, each of the end-nodes includes application and system software components that may also be monitored by management system 102. The switches, SW_1 through SW_3 may comprise network switches for establishing OSI Level 2 and/or Level 3 connectivity among components in the respective subnets. The routers, R_1 through R_3 comprise data relay devices for establishing OSI Level 3 connectivity among components within and across the respective subnets.

MS instances 104, 106, and 108 are configured to manage respective service domains that intersect various portions of subnets 116, 118, and 120. For example, MS instance 104 is configured to manage a service domain 110 comprising router R_1 within subnet 116 and router R_2 within subnet 118. MS instance 106 is configured to manage a service domain 112 comprising router R_3, switch SW_3 and end-nodes HOST_5 and HOST_6 within subnet 120. MS instance 108 is configured to manage a service domain 114 comprising switch SW_1 and end-nodes HOST_1 and HOST_2 within subnet 116, and switch SW_2 and end-nodes HOST_3 and HOST_4 within subnet 118.

Each of MS instances 104, 106, and 108 is configured to monitor system entities within their respectively assigned service domains to, for example, determine performance metrics and other conditions incident to operation of the system entities individually or in various combinations. To this end, MS instances 104, 106, and 108 deploy service agents, such as service agents A1-A6, for each of the individual system entities to be monitored. The service agents may maintain a local view of system management information and translate that local view into a global format and protocol such as an SNMP-specific form.

Each of the depicted service agents A1 through A6 generally represents a relatively small code item (e.g., command, query) configured to monitor a respective target system entity by detecting and collecting operation related data including performance metrics such as link speed and throughput, processor utilization by a specified application, etc. For instance, MS instance 104 deploys a service agent A1 to monitor router R_1 and service agent A2 to monitor router R_2. While not expressly depicted in FIG. 1, additional service agents may be deployed to monitor system entities such as servers and CPUs within end-nodes.

MS instances 104, 106, and 108 collect data, including operational metrics, from the service agents to generate records within respective local databases. The management records for service domains 110, 112, and 114 are collected within service domain databases 126, 128, and 130, respectively. For instance, database 128 includes multiple tables TBL_1 through TBL_N that contain data records storing data collected by service agents including A_5 and A_6 for each of the managed components within service domain 112. Service domain databases 126, 128, and 130 may further contain records specifying management system configuration, such as may be determined by any of the MS instances and/or by MS host 132. For example, if management system 102 implements SNMP-based management, databases 126, 128, and 130 may comprise management information bases (MIBs).

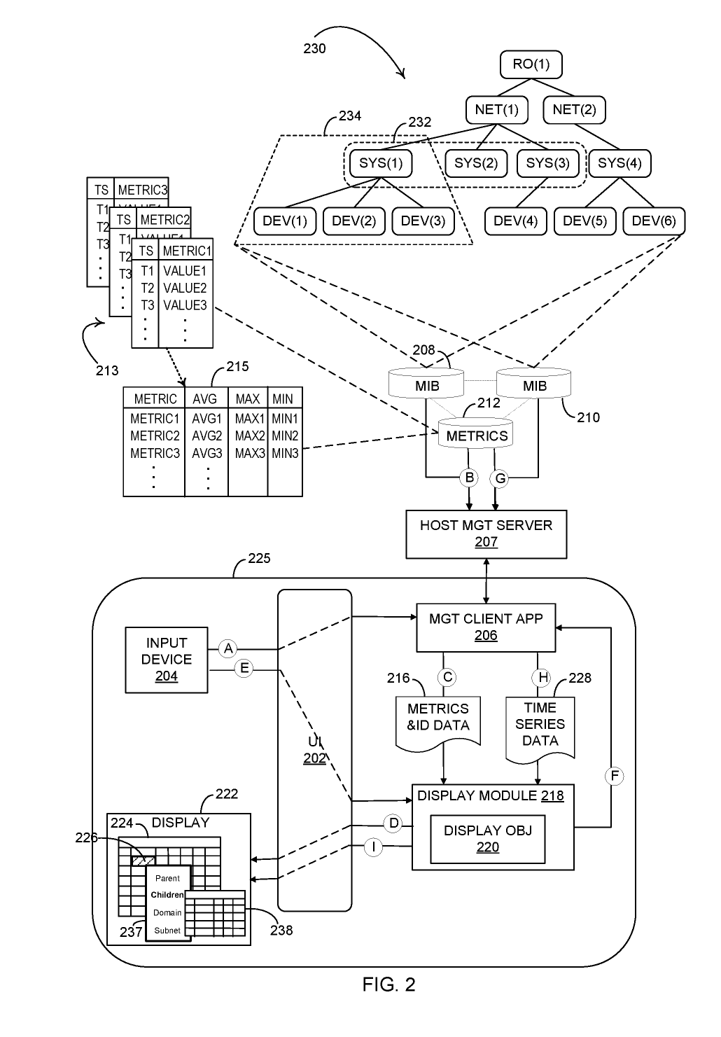

In some embodiments, databases 126, 128, and 130 include profile definitions of the system entities within the respective service domains as well as collected metric data for the system entities. As depicted and described in further detail with reference to FIGS. 2-5, the profile definitions may comprise individual identifier (ID) information corresponding to a particular entity and additional, configuration-based ID information. The combination of individual ID information (e.g., alphanumeric string uniquely identifying a system entity) with configuration-based ID information may be referred to herein as constituting multi-dimensional entity ID information.

In some aspects, configuration-based ID information includes information describing, identifying, or otherwise indicating one or more correlations among two or more system entities. For instance, switches SW_l and host device HOST_2 are correlated in terms of being members of the same service domain 114 that was configured by MS instance 108 and/or MS host 132. In this case, MS instance 108 may generate a record constituting associations within or among one or multiple relational tables that correlate SW_1 and HOST _2 by virtue of a common relation (i.e., membership) to service domain 114. In addition to specified correlations based on service domains, any of the MS instances and/or MS host 132 may generate records that specify target system operational configuration correlations (e.g., hierarchical relations) among system entities. For example, MS instance 106 may generate one or more records within database 128 that correlate router R_3 and switch SW_3 as belonging to the same subnet 120.

The management records storage within databases 126, 128, and 130 are retrieved and configured as relational table records 138 within a management database 136. In some embodiments, a collection engine 134 deployed from MS host 132 retrieves the management records from the domain databases on a periodic basis and/or in response to a client request, such as from a client 150. The relational table records may be configured to logically associate an entity ID with one or more operational metric entries. The metric entries themselves may be stored as records that associate series of timestamp values with series of respective metric data values. The various logical associations and mappings such as among related system entities in combination with the time series nature of the metric data results in potentially inefficient retrieval, temporary storage of, and display of management system records by a client, such as client 150.

The techniques and mechanisms described herein enable efficient retrieval and display of data from potentially vast numbers of multi-dimensional data records that frequently include redundancies across records. In one aspect, collection engine 134 is configured, using any combination of coded software, firmware, and/or hardware, to generate and configure system management data within and across relational tables based, at least in part, on specified correlations among the target system entities. The system management data may be retrieved from domain databases 126, 128, and 130 via communications with the respective MS instances. Collection engine 134 configures the system management data in relational table records 138 within a host management database 136 from which the tabular data can be accessed by client 150.

Client computer 150 is an end-node processing system including a processor 152 and associated computer memory 155 from which a web browser 158 and a management client 160 executes. In some embodiments, management client 160 requests and retrieves system management information in the form of multi-entry records wherein each of the multiple entries in each record corresponds to a record field (e.g., a columnar field displayed in a table). As explained in further detail with reference to FIGS. 2-8, client computer 150 may include a processing component such as a javascript process that executes within the processing space of web browser 158 to render time series metric data in accordance with various embodiments.

FIG. 2 is a block diagram illustrating a system architecture for rendering time series metric data in accordance with some embodiments. The system includes a host management system and a management client node 225. Client node 225 comprises a combination of hardware, firmware, and software configured to communicate with implement system management data transactions with the host management system. The host management system includes, in part, a host management server 207 that is communicatively connected to a management client application 206 within client node 225.

Host management server 207 may include some or all of the management system components and functionality described and depicted with reference to distributed management system 102 in FIG. 1. For instance, host management server 207 may include a collection engine for collecting and retrieving operational metric data from system entities within a target system (not depicted in FIG. 2). The metric data may be stored in one or more relational tables such as metric data table 212, which may comprise multiple series of timestamp-value pairs. For instance, metric data table 212 includes multiple files 213 each comprising a series of timestamps T₁-T_{N} and corresponding metric values Value₁=Value_{N} collected for one or more of the system entities. Metric table 212 further includes a file 215 containing metric values computed from the raw data collected in association with individual timestamps. As shown file 215 includes multiple records that associated a specified metric with computed average, max, and min values for the metrics specified within files 213.

The operational metric data is collected and stored in association with system entity profile data corresponding to the system entities from/for which the metric data is collected. The profile data may be stored in relational tables such as management information base (MIB) tables 208 and 210. Individually or in combination, MIB tables 208 and 210 contain entity profile information hierarchically configured in a particular target system configuration. The depicted example includes a tree structure 230 comprising multiple hierarchically configured nodes. A root node RO(1) is associated with child network nodes NET(1) and NET(2). The tree structure 230 associates NET(2) node as a parent with respect to a child system node SYS(4), which in turn, is associated as a parent with respect to device node DEV(5) and DEV(6). In addition to operational configuration groupings/associations specified by the associations of tree structure 230, the nodes may be grouped/associated based on management system collection configurations such as service domain configurations. For instance, the NET(1) node is associated via the tree structure as a parent node with respect to system nodes SYS(1), SYS(2), and SYS(3), which are collectively configured within a service domain 232. There may also be overlap between operational configuration and a service domain groupings. For example, the child-parent configuration of device nodes DEV(1), DEV(2), and DEV(3) with respect to system node SYS(1) overlaps the grouping of all of these nodes within a service domain 234.

As visually represented in FIG. 2 by interconnecting dashed connectors, the relational tables 208, 210, and 212 may share cross-table key indices enabling system management data records to be generated from information across two or more of the tables. The depicted system includes components for utilizing the relationally configured system management data to efficiently access and render time series operational metric data based on user interface (UI) interactions within client node 225. Client node 225 includes a user input device 204 such as a keyboard and/or display-centric input device such as a screen pointer device. A user can use input device 204 to enter commands (e.g., displayed object select) or data that are processed via a UI layer 202 and received by the system and/or application software executing within the processor-memory architecture (not expressly depicted) of client node 225.

User input signals from input device 204 may be translated as keyboard or pointer commands directed to management client application 206. In some embodiment, client application 206 is configured, in part, to generate graphical objects, such as a management display object 220 by a display module 218. Graphical representations of management display object 220 and are rendered via UI layer 202 on a display device 222, such as a computer display monitor.

The following description is annotated with a series of letters A-I. These letters represent stages of operations for rendering system management data. Although these stages are ordered for this example, the stages illustrate one example to aid in understanding this disclosure and should not be used to limit the claims. Subject matter falling within the scope of the claims can vary with respect to the order and type of the operations.

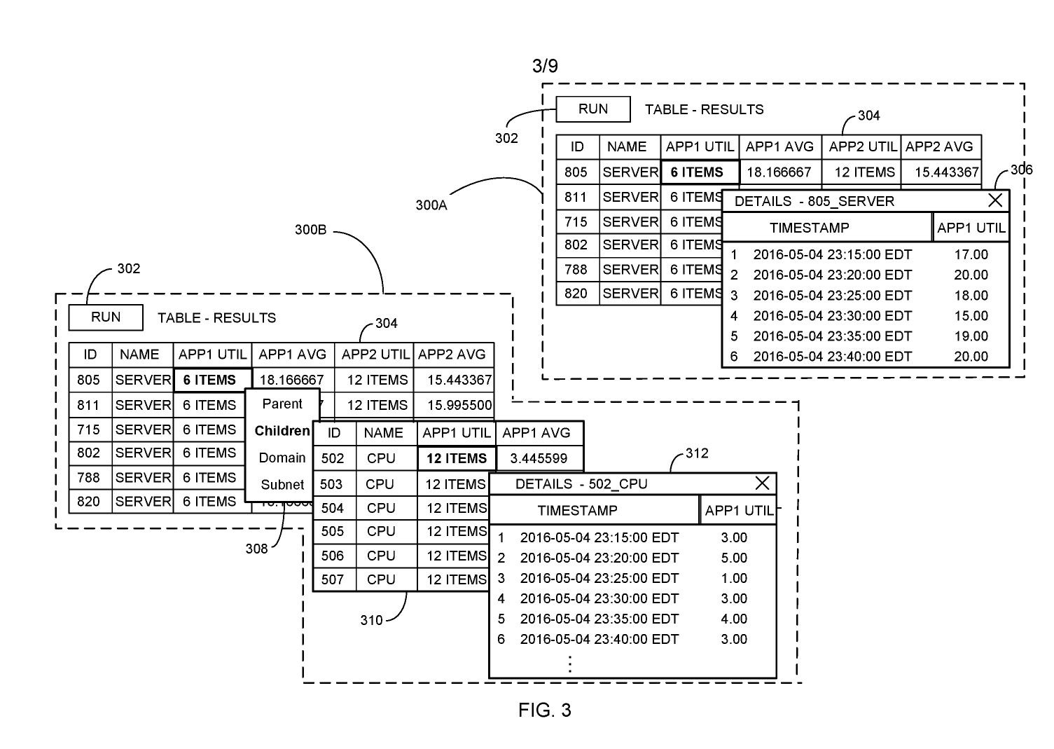

At stage A, input device 204 transmits an input signal via UI layer 202 to client application 206, directing client application 206 to request system management records from host management server 207. For instance, an OpenAPI REST service such as the OData protocol may be implemented as a communication protocol between client application 206 and management server 207. In response to the request, host management server 207 retrieves tabular system management data from tables 208 and 212 at stage B. The retrieved data may include processed operational metric data stored in metric data table 212 such as the average, max, and min data in file 215. The retrieved data further includes entity ID information obtained from MIB 208. As stage C, the processed metric data together with the entity ID information is received by client application 206 and passed as ID and metric data 216 to display module 218. At stage D, the data 216 is processed by display module 218 via UI 202 to render/display a table object 224 within display device 222. As depicted and described in further detail with reference to FIG. 3, table object 224 may comprise a two-dimensional table having columnar fields and row-wise records (row records) in which each of the row records includes a system entity ID entry within a columnar entity ID field. As also described in further detail with reference to FIG. 3, each of the row records include at least one metric field entry within a columnar field that displays an operational metric ID (e.g., “APP1 UTILIZATION”).

At stage E, display module 218 receives a signal via UI 202 from input device 204 corresponding to an input selection of an entry 226 within table object 224. For instance, the input selection may comprise a graphical UI selection of entry 226. In response to the selection signal, display module 218 transmits a request to client application 206 requesting metric data corresponding to the metric ID displayed in the column containing entry 226 (stage F). The request further specifies a system entity ID corresponding to the system entity ID included in the row containing entry 226. In response to the request, client application 206 transmits a request to host management server 207 requesting additional operational metric data associated with the system entity corresponding to the system entity ID. For example, in response to a first type of input signal (e.g., left mouse click) received proximate to entry 226, client application 206 may request and retrieve time series data (e.g., timestamp metric value pairs) from host management server 207. At stage G, host management server 207 retrieves the time series data and associated profile data from tables 212 and 210, and forwards the retrieved data to client application 206. At stage H, client application 206 passes the retrieved data as time series data 228 to display module 218, which displays the time series metric data in association with entry 226 via UI 202 at stage I.

In some embodiments, a second type of input signal (e.g., right mouse click) may be received at stage E. In response to a second type of input signal received proximate to entry 226, client application 206 may display an interface object (e.g., drop down selection menu) 237 containing selectable elements such as “PARENT,” “CHILD,” “DOMAIN,” etc. Each of the selectable elements visually specifies a relation ID that indicates a correlation of one or more other system entities with respect to the system entity corresponding to the entity ID displayed in the row record containing entry 226. In response to input selection of one of the elements within interface object 237, client application 206 transmits a request to host management server 207 requesting system entity profile information for one or more system entities. For instance, in response to selection of a selectable element displaying CHILD, client application 206 requests profile information of system entities that are associated as children nodes within tree structure 230 of the system entity identified in the row containing entry 226. In response to the request, host management server 207 retrieves and passes the requested profile data to client application which displays it via UI 202 in a second table object 238. As depicted and described in further detail with reference to FIG. 3, second table object 238 includes entries that are each mapped to respective columnar fields and row records.

FIG. 3 depicts display object sets 300A and 300B for rending time series metric data in accordance with some embodiments. The object sets may be generated by the components and operations described in FIGS. 1, 2, 4 and 5. Object set 300A includes a query execution button 302 for generating a table that displays system management data specified by query parameters that may be user-specified. In response to a graphical input selection of button 302, a client application, such as client application 206, requests/retrieves system management data from a host management system, such as host system 207. The retrieved data includes system entity ID information and metric information displayed within a table object 304. As shown, the entity ID information is displayed within ID and NAME columnar fields. Individually, or in combination, the ID and NAME fields uniquely identify an individual system entity within the target system being managed.

The metric information is displayed within columnar fields APP1 UTIL, APP1 AVG, APP2 UTIL, and APP2 AVG. The APP1 UTIL field displays metric counts corresponding to a number of time series values for the metric APP1 UTIL. The APP1 AVG field displays a single cumulative value (average value) of the number of time series values represented in the APP1 UTIL field. Similarly, the APP2 UTIL field displays metric counts corresponding to a number of time series values for the metric APP2 UTIL. The APP2 AVG field displays a single cumulative value (average value) of the number of time series values represented in the APP2 UTIL field.

In response to a first user select signal (e.g., left mouse click) of one of any of the metric count entries within the APP1 UTIL or APP2 UTIL fields, the client application displays a window object that displays time series metric data. For instance, in response to selection of the metric count entry “6 ITEMS” within the first row record of table object 304, the client application displays a window object 306 containing time series data. As shown, the time series data comprises time series records in which operational metric values are each associated with a respective timestamp.

Like object set 300A, object set 300B includes query execution button 302 that may be selected to generate table object 304 based on user-specified query parameters (not depicted). In response to input select of button 302, the client application requests/retrieves system entity ID information and metric information to be displayed within table object 304. In response to a second user input select signal (e.g., mouse right click input) of one of any of the metric count entries within the APP1 UTIL or APP2 UTIL fields, the client application displays an interface object (e.g., drop-down menu) containing multiple selectable elements that each indicate a correlation of another system entity to the system entity corresponding to the entity ID entry within the row record containing the selected metric count entry. For example, in response to selection of the metric count entry “6 ITEMS” using the second type of input select signal, the client application displays an interface object 308 that includes selectable elements having displayed relation IDs Parent, Children, Domain, and Subnet.

Each of the relation IDs indicates a correlation of one or more system entities to the system entity corresponding to the entity ID entry within the row record containing the selected metric count entry. For instance, the Children relation ID specifies system entities that are children nodes of the system entity 805_SERVER. In response to an input selection of one of the selectable elements within interface object 308, a second table object is displayed that includes ID and metric information for system entities corresponding the relation ID of the selected element. For instance, in response to selection of the element displaying the Children relation ID, the client application displays a table object 310 that includes columnar ID and metric fields. The entity ID and metric information displayed in table object 310 may be retrieved in response to selection of the Children element or may have been retrieved from the host management system in response to input selection of query execution button 302. Similar to table object 304, the entity ID information for table object 310 is displayed within ID and NAME columnar fields that individually or in combination uniquely identify individual system entities. As shown, the entity IDs specify CPU_502 through CPU_507 which are associated within the management system hierarchy as children of SERVER_805.

In addition to entity ID information, each of the row records includes metric fields associated with the metric field containing the count entry that was selected in table 304. As shown, each of the row records in table object 310 includes APP1 UTIL and APP1 AVG fields corresponding to the same application utilization metric in table object 304. In response to selection of a metric count entry within table object 310, the client application displays a window object containing time series metric data for a system entity corresponding to the entity ID displayed in the row record containing the selected metric count entry. As shown, in response to selecting the 12 ITEMS count entry, the client application displays a window object 312 containing a series of twelve metric values for APP1 UTIL each having a corresponding timestamp.

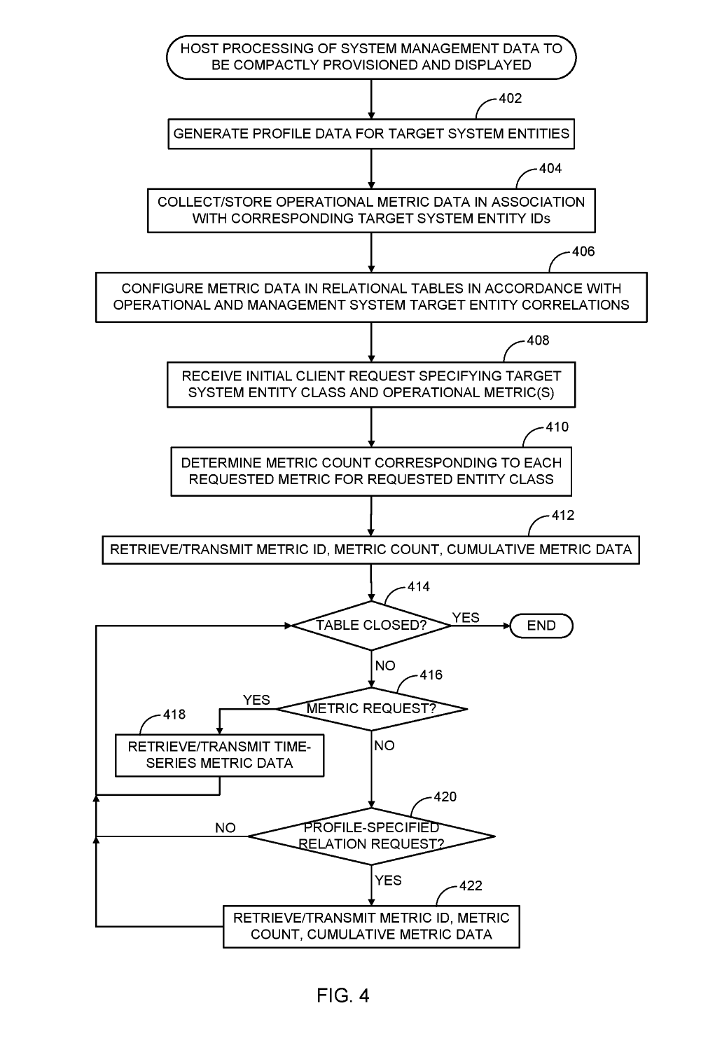

FIG. 4 is a flow diagram depicting operations and functions for generating and provisioning tabular data including table entries that are associated with multi-dimensional ID information in accordance with some embodiments. The operations and functions depicted in FIG. 4 may be performed by any of the systems and components illustrated and described with reference to FIGS. 1-3. The process begins as shown at block 402 with a management system generating target system profile data such as may be maintained in one or more MIBs. The management system collects and stores operational metric data such as by use of agents and/or agentless instrumentation and monitoring of the target system entities (block 404). The operational metric data may be collected in tabular files such as timestamp value pairs with the metric data files with each of the metric data files relationally associated with a corresponding target system entity.

At block 406, the management system configures the metric data in relational tables based on operational and management system target entity correlations. For example, the MIBs may define hierarchical associations among the system entities such as parent and child. The relational tables may be configured to associate metric data collected for one system entity with metric data collected for one or more other system entities based on the MIB or other associations such as those described with reference to FIG. 2.

At block 408, a host management system server receives a client application request for system management data. The request may specify a system entity ID classification defined by multiple query parameters/criteria such a Domain1 Servers. The request may further specify operational metric information to be retrieved. For example, the request may specify one or more metrics such as application utilization, processor utilization, etc. The management system server retrieves entity ID and metric information data from relational tables based on the request criteria. The metric information may include time series metric data comprising operational metrics values and corresponding timestamps. At block 410, either a node in the management system (e.g., the management system server) or the client application determines a metric count corresponding to each of the requested metrics for each of the system entities within the requested class.

At block 412, the management system server transmits the metric information including metric ID and corresponding metric value counts as well as corresponding entity ID information to the client application. The client application renders a table object that displays the received management system information. The table object comprises entries that are each mapped to a respective one or multiple columnar fields and a respective one of multiple row records. The columnar fields are associated with respective field headers that indicate an entity ID field (e.g., “Name,” “ID,” etc.) or a metric information field (e.g., “Processor Util,” “Avg Util,” etc.). The metric information fields include one or more metric count fields having entries that each display a metric count indicator (e.g., an integer number) within each of the respective row records. Each of the count indicators corresponds to a number of time instance values that were collected over a series of points in time.

A graphical user input component may be used to interact with the client application by selecting various objects/elements displayed within the table object. For example, a pointer device (e.g., a mouse) may be used to enter an input select signal for one of the metric count entries. As shown at blocks 414 and 416, while the table object remains open, the client application may detect an input select signal for a metric count entry and, in response, request additional metric information from the host management server. In response to a request for addition metric data associated with at least one system entity specified in the request received at block 408, the management system server retrieves corresponding time-series metric data and transmits the data to the client application (block 418). Alternatively, the client may send a request for additional metric data for system entities associated with an entity identified in the table object (block 420). In response to such a request, the management system server retrieves metric information including metric ID and metric count for the other, associated system entities and transmits the information to the client application (block 422).

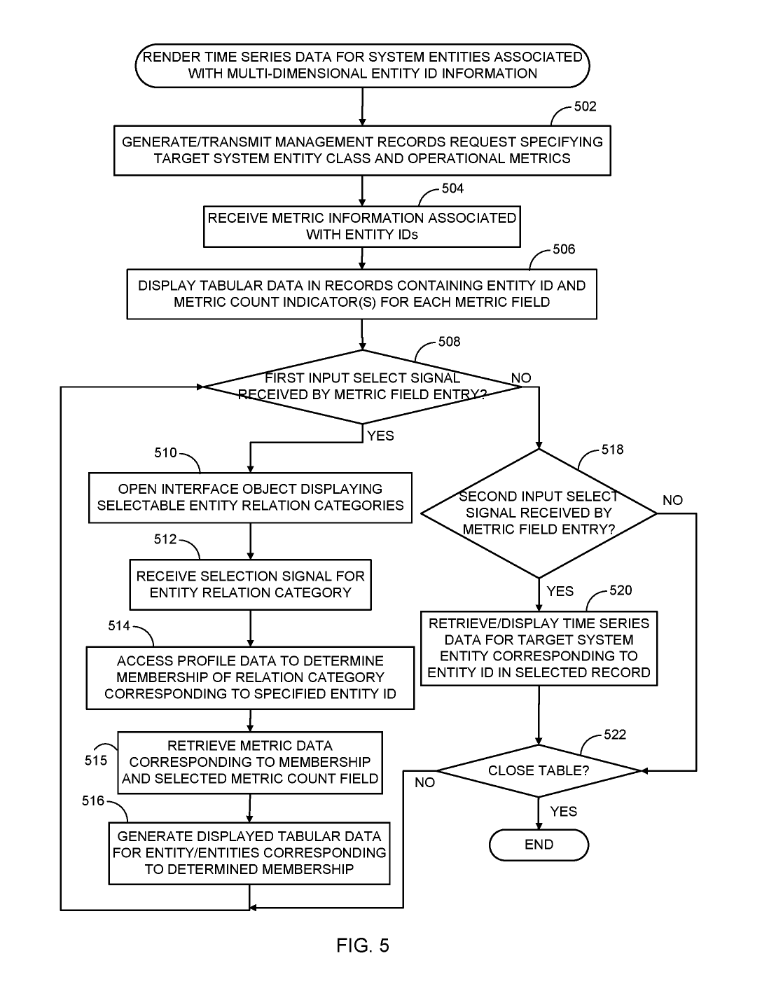

FIG. 5 is a flow diagram illustrating operations and functions for rendering time series data associated with system entities having multi-dimensional entity ID information in accordance with some embodiments. The operations and functions depicted in FIG. 5 may be performed by any of the systems and components illustrated and described with reference to FIGS. 1-3. The process begins at block 502 with a management client application generating and transmitting a system management data request to a system management host server. The request may specify a system entity ID classification defined by multiple query parameters/criteria such as a request for operational metrics for servers within Domain1. The request may further specify the particular operational metric information to be retrieved. For example, the request may specify one or more metrics such as application utilization, processor utilization, etc. The management system server retrieves entity ID and metric information data from relational tables based on the request criteria. The metric information may include time series metric data comprising operational metrics values and corresponding timestamps. At block 504, the client application receives the requested tabular data, including metric counts corresponding to each of the requested metrics for each of the system entities within the requested class.

At block 506, the client application displays the received tabular data in a table object comprising table entries that are each mapped to a respective columnar field and a respective row record. Each of the row records includes an entity ID entry corresponding to a particular target system entity. In addition to at least one entity ID field, the columnar fields include one or more metric fields each having headers displaying a metric ID. The record entries within the metric fields may include a cumulative metric value such as an average, max, min, etc. The record entries within at least one of the fields each specify metric counts corresponding to a number of time series metric values.

The displayed table object presents multiple selectable elements, including metric count entries. The metric count entry elements are selectable by at least two different input select signals, such as left and right button mouse selections. In response to a first of the input select signals received proximate to a metric count entry, the client application opens an interface object that displays multiple entity relation elements (blocks 508 and 510). The relation elements display a relation ID that indicates a correlation of one or more system entities with respect to the system entity identified in the row record containing the selected metric count entry. For instance, the interface object may be a drop down menu displaying relation elements “Parent,” “Child,” “Domain,” “Subnet,” etc.

In response to receiving a select signal (e.g., pointer device selection) for one of the relation elements, the client application accesses entity profile data to determine the membership class corresponding to the selected relation element (blocks 512 and 514). For example, if the system entity identified in the row of the metric count entry selected at block 508 is a server, Server1, and the relation element selected at block 512 is “Domain1,” client application will access profile to determine which domain Server1 is assigned. The client application may utilize the determined domain ID to identify other system entities assigned to the same domain.

At block 515, the client application retrieves entity profile and metric information corresponding to the determined membership and to the metric count entry selected at block 508. Continuing with the example, if the membership of Domain1 includes Server2, Server3, and Server 4, and if the metric count entry is contained within an App1 Utilization metric field, the client application retrieves entity profile information for Server2, Server3, and Server4 and further retrieves App1 Utilization metric information such as metric counts and cumulative results (e.g., Average) for each of the three identified servers. As depicted and described with reference to FIGS. 1-3, the client application may perform steps 514 and 515 in cooperation with management system components such as a management system host and storage. At block 516, the client application generates/displays a table object containing multiple row records that each include identifiers for the system entities identified at block 514. The table further includes at least one columnar field that displays a metric ID (e.g., displayed in column header) and contains metric count entries.

For the table generated at block 516 or at block 506, a second input select signal distinct from the first input select signal may be received proximate to a metric field entry (block 518). If so, the client application retrieves and displays time series data for the target system entity corresponding to the system entity ID displayed in the row record containing the selected metric field entry (block 520). For foregoing processes may continue until the displayed table object is closed (block 522).

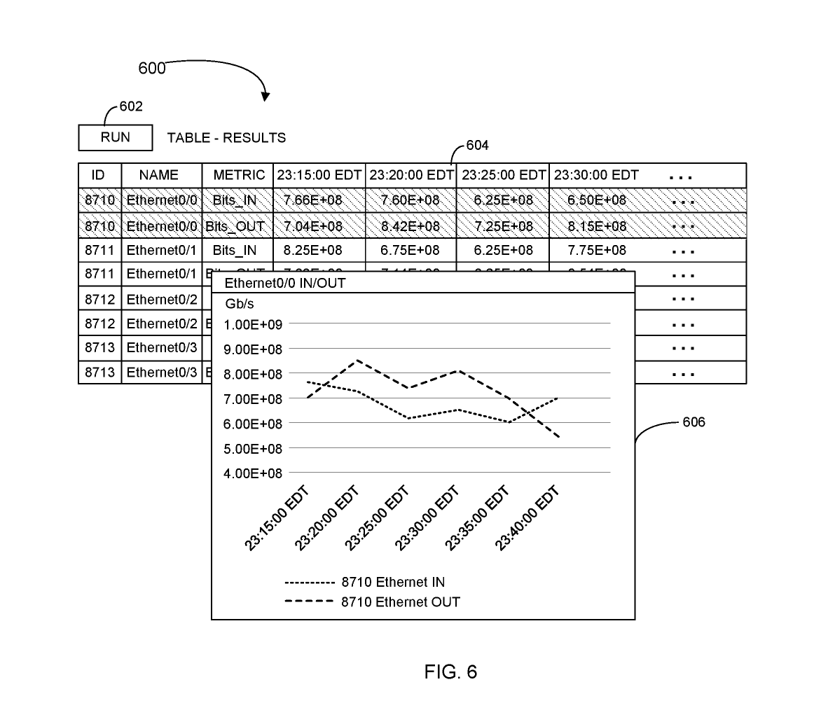

FIG. 6 illustrates display objects for rending time series metric data in accordance with some embodiments. The depicted display objects comprise an object set 600 that may be generated by the components and operations described in FIGS. 1, 2, 4, and 8. Object set 600 includes a query execution button 602 for generating a table that displays system management data specified by query parameters that may be user-specified. In response to a graphical input selection of button 602, a client application, such as client application 206, requests/retrieves system management data from a host management system, such as host system 207. The retrieved data includes system entity ID information and corresponding metric information displayed within a table object 604. As shown, the entity ID information is displayed within ID and NAME columnar fields. Individually, or in combination, the ID and NAME fields uniquely identify an individual system entity within the target system being managed. For example, the depicted entity ID information within each record includes a number associated with a respective Ethernet port.

In contrast to the embodiments in FIG. 3, the metric information within table object 604 is displayed as a sequence of timestamped metric values. As shown, each row records associates the entity ID information with a metric ID field, METRIC, and a series of timestamp value entries that associate a particular timestamp indicated in the columnar headers with respective metric values. For instance, the depicted metric information in each record is identified as either bits input to or bits output from (Bits_IN or Bits_OUT) the Ethernet port identified in each record. The metric information further includes individual timestamped metric value entries corresponding to the identified Bits_IN or Bits_OUT metric for the identified Ethernet port at the respective timestamps indicated in the respective columnar headers.

In response to a first user select signal (e.g., left mouse click) of one of any of the row records within table object 604, the client application displays a window object that displays time series metric data. For instance, in response to selection of the first and second row records of table object 604, the client application displays a highlight indicator in association with both selected records and displays a window object 606. The depicted highlight indicator comprises shading the entries within each of the selected records. Window object 606 contains graphical time series metric data corresponding to the metrics (i.e., Bits_IN and Bits_OUT) and the system entity (i.e., Ethernet0/0 port) identified in the selected rows. As shown, the time series data is effectively a series of points interconnected by displayed lines designated within the window legend as belong to one of the two metric types.

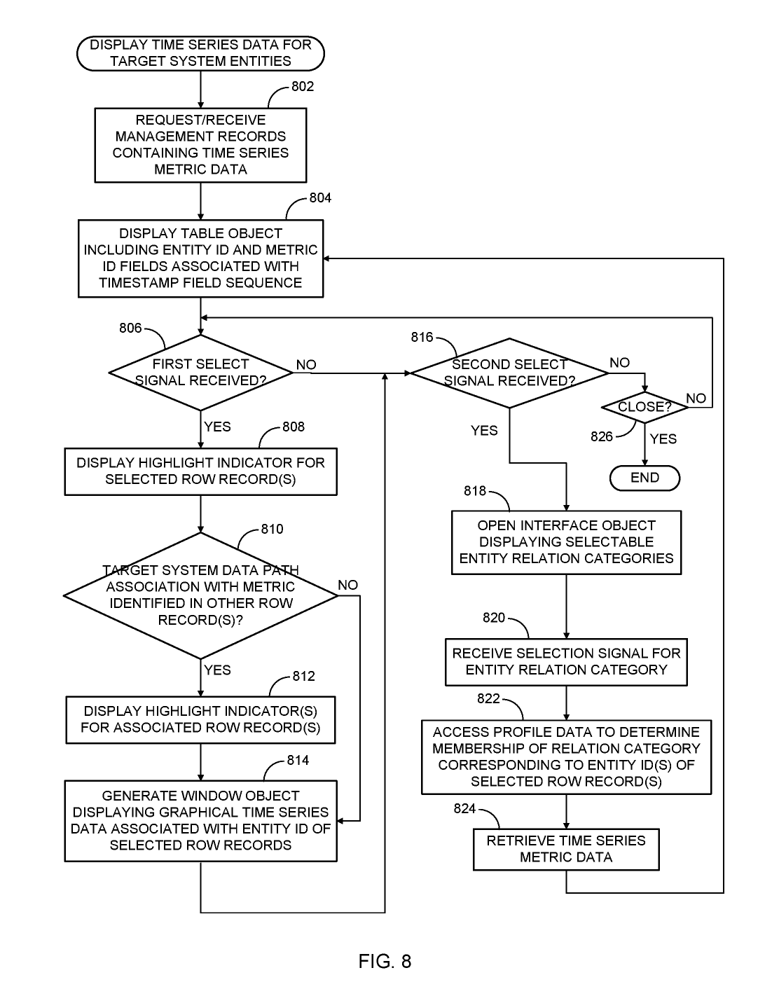

In some embodiments, and as disclosed in further detail with reference to FIG. 8, the client application may execute a data path association/relation determination in response to a user selection of one or more row records. For example, in response to detecting a user selection of the first row record, the client application determines/identifies whether a data path association exists between the metric specified by the selected record (i.e., Bits_IN of Ethernet0/0) and one or more metrics specified by one or more of the other records within table object 604. The client application may access system entity profile records to determine data paths shared by different system entities. The client application may also or alternatively determine data path associations for inputs and outputs for a same system entity such as the identified Bits_IN and Bits_OUT paths for port Ethernet0/0. Continuing with the example, the client application may display the time series representation of the Ethernet0/0 Bits_OUT metric in response to determining the association.

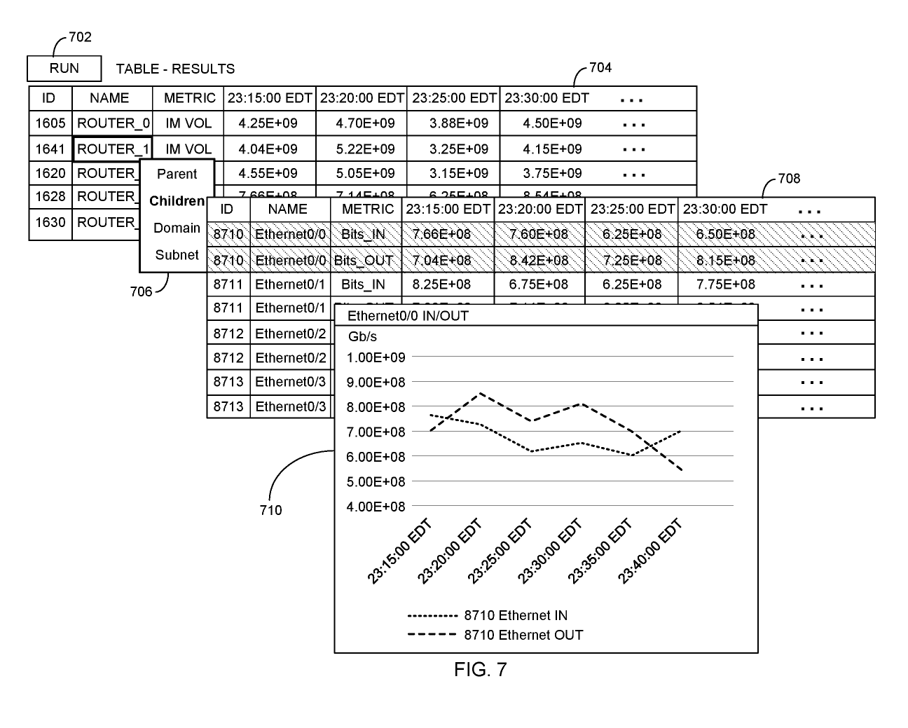

FIG. 7 depicts display objects for rendering time series metric data in accordance with some embodiments. The display objects include a query execution button 702 that may be selected to generate a table object 704 based on specified query parameters. The client application requests/retrieves system entity ID information for router entities ROUTER_0 through ROUTER_4. The client application also retrieves metric information categorized as instant message volume (IM VOL) for each of routers ROUTER_0 through ROUTER_4 to be displayed within table object 704. In response to a second user input select signal (e.g., mouse right click input) of one of any of the system entity ID entries within the NAME field, the client application displays an interface object (e.g., drop-down menu) containing multiple selectable elements that each indicate a correlation of another system entity to the selected system entity ID entry. For example, in response to selection of the entity ID entry ROUTER_1 using the second type of input select signal, the client application displays an interface object 706 that includes selectable elements having displayed relation IDs Parent, Children, Domain, and Subnet.

Each of the relation IDs indicates a correlation of one or more system entities to the system entity specified by the selected entity ID entry. For instance, the Children relation ID specifies system entities that are children nodes of ROUTER_1. In response to an input selection of one of the selectable elements within interface object 706, a second table object is displayed that includes entity ID, metric ID (which may incorporate entity ID), and timestamped metric values for system entities corresponding the relation ID of the selected element. For instance, in response to selection of the element displaying the Children relation ID, the client application displays a table object 708 that includes columnar ID and metric fields. The entity ID and metric information displayed in table object 708 may be retrieved in response to selection of the Children element or may have been retrieved from the host management system in response to input selection of query execution button 702. Similar to table object 704, each of the row records within table object 708 includes a system entity ID entry (Ethernet ports 0/0 through 0/3), a metric ID entry (Bits_IN or Bits_OUT), and multiple timestamp value entries each comprising a metric value and corresponding timestamp.

In response to a first user select signal (e.g., left mouse click) of one of any of the row records within table object 708, the client application displays a window object that displays time series metric data. For instance, in response to selection of the first and second row records of table object 708, the client application displays a highlight indicator in association with both selected records and displays a window object 710. The depicted highlight indicator comprises shading the entries within each of the selected records. Window object 710 contains graphical time series metric data corresponding to the metrics (i.e., Bits_IN and Bits_OUT) and the system entity (i.e., Ethernet0/0 port) identified in the selected rows.

FIG. 8 is a flow diagram illustrating operations and functions for rendering time series data in accordance with some embodiments. The operations and functions depicted and described with reference to FIG. 8 may be performed by any of the systems, subsystems, and software and hardware components described with reference to FIGS. 1, 2, 6, and 7. The process begins as shown at block 802 with a client application requesting and receiving management records containing time series metric data. At block 804, the client application displays the time series metric data in a first table object. The table object includes multiple table entries that are each mapped to a respective one of multiple columnar fields and a respective one of multiple rows. In some embodiments, such as depicted in FIGS. 6 and 7, the columnar fields include an entity ID field, a metric ID field, and a series of multiple timestamp value fields.

The displayed table object includes field entries that display information and also serve as selectable elements. In response to receiving neither a first nor a second input select signal proximate to the selectable elements, the table may be closed (blocks 806, 816, and 826). In response to receiving a first input select signal proximate to one or more row records (block 806), the client application displays a highlight indicator in association with the one or more selected records (e.g., bolded outline or shaded record entry) at block 808. In some embodiments, the client application may further determine whether a target system data path association exists between a metric specified in the metric ID field of the one or more selected records and one or more other metrics specified in metric ID fields of other records (block 810). If no associated data paths are determined/identified, control passes to block 814 with the client application displaying, within a window object, time series metric data corresponding to the system entities specified by the selected record(s).

In response to identifying an associated data path at block 810, the client application displays a highlight indicator in association with the record that specifies the metric sharing the determined association (block 812). In conjunction with highlighting the selected and associated records, the client application displays, within a window object, time series metric data corresponding to the system entities specified by the highlighted (selected and associated) record(s) at block 814. In some embodiments, displaying the window object comprises displaying the time series data as points in a two-dimensional graph that includes a first axis corresponding to a metric value range and a second axis corresponding to a time range.

The client application may utilize entity profile information to further optimize flexibility and efficiency of the display of time series metric data. Following display of the window object at block 814 or in the absence of the first signal type at block 806, the client application may detect a second select signal input proximate to a metric ID entry of one of the row records (block 816). In response to the second select signal, the client application opens an interface object that displays multiple entity relation elements (block 818). The relation elements display a relation ID that indicates a correlation of one or more system entities with respect to the system entity identified in the row record containing the selected metric ID entry. For instance, the interface object may be a drop down menu displaying relation elements “Parent,” “Child,” “Domain,” “Subnet,” etc.

In response to receiving a select signal (e.g., pointer device selection) for one of the relation elements, the client application accesses entity profile data to determine the membership class corresponding to the selected relation element (blocks 820 and 822). For example, if the system entity identified in the row of the metric count entry selected at block 816 is a router, ROUTER_1, and the relation element selected at block 512 is “Children,” client application will access profile to determine, based on target system configuration hierarchy, which system entities are children of ROUTER_1. At block 824, the client application retrieves entity profile and metric information corresponding to the determined membership which is then displayed as control returns to block 804.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

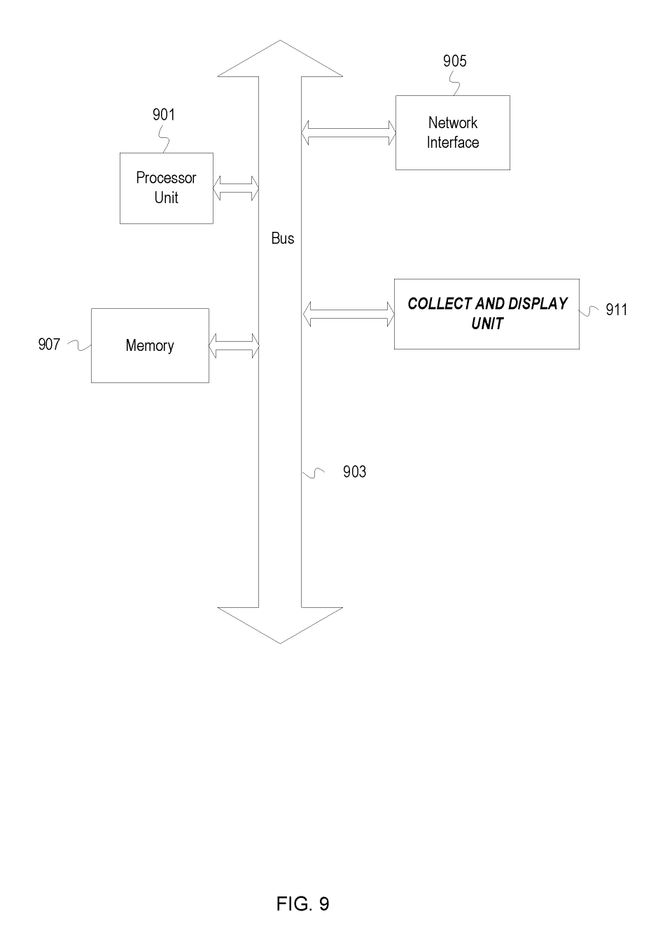

FIG. 9 depicts an example computer system that implements time series metric data rendering in accordance with an embodiment. The computer system includes a processor unit 901 (possibly including multiple processors, multiple cores, multiple nodes, and/or implementing multi-threading, etc.). The computer system includes memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 903 (e.g., PCI, ISA, PCI-Express, HyperTransport® bus, InfiniBand® bus, NuBus, etc.) and a network interface 905 (e.g., a Fiber Channel interface, an Ethernet interface, an internet small computer system interface, SONET interface, wireless interface, etc.). The system also includes a time series collection and display subsystem 911. Any one of the previously described functionalities may be partially (or entirely) implemented in hardware and/or on the processor unit 901. For example, the functionality may be implemented with an application specific integrated circuit, in logic implemented in the processor unit 901, in a co-processor on a peripheral device or card, etc. Further, realizations may include fewer or additional components not illustrated in FIG. 9 (e.g., video cards, audio cards, additional network interfaces, peripheral devices, etc.). The processor unit 901 and the network interface 905 are coupled to the bus 903. Although illustrated as being coupled to the bus 903, the memory 907 may be coupled to the processor unit 901.

While the aspects of the disclosure are described with reference to various implementations and exploitations, it will be understood that these aspects are illustrative and that the scope of the claims is not limited to them. In general, techniques for rendering time series metric data as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method for displaying time series metric data, said method comprising:
generating time series metric data that include, metric values associated with system entities; and
a timestamp associated with each of the metric values;
displaying the time series metric data in a first table object comprising multiple table entries that are each mapped to a respective one of multiple columnar fields and a respective one of multiple row records, wherein the columnar fields include a system entity identifier (ID) field, a metric identifier field, and multiple timestamp value fields; and
in response to a first select signal received proximate to one or more of the row records, displaying, within a first window object, time series metric data corresponding to one or more system entities that are each associated with a system entity ID specified by the system entity ID field of the selected one or more row records.

2. The method of claim 1, wherein said displaying the time series metric data in the first table object comprises:
within each row record of the first table object, displaying a system entity ID entry in association with a metric ID entry; and
displaying an operational metric value within each columnar entry of the timestamp value fields.

3. The method of claim 2, wherein said displaying time series metric data within the first window object comprises displaying the time series metric data as points in a two-dimensional graph that includes a first axis corresponding to a range of metric values and a second axis corresponding to a time range.

4. The method of claim 1, further comprising:
in response to the first select signal received proximate to a first row record of the first table object, determining a data path association between a first metric specified in the metric ID field of the first row record and a second metric specified in the metric ID field of a second row record; and
wherein said displaying time series metric data within the first window object comprises, in response to determining the data path association, displaying time series representations of the first metric and the second metric as points in a two-dimensional graph that includes a first axis corresponding to a range of metric values and a second axis corresponding to a time range.

5. The method of claim 4, further comprising:
displaying, within the first table object, a highlight indicator associated with the first row record; and
in response to determining the data path association, displaying a highlight indicator associated with a second row record that specifies the second metric.

6. The method of claim 1, further comprising:
associating entity profile data with a first table entry within a first row record of the one or more selected row records, wherein the first table entry is within a columnar field that displays a system entity ID, and wherein the entity profile data includes,
profile data for a first system entity corresponding to the system entity ID entry included in the first row record; and
profile data for at least one other system entity.

7. The method of claim 6, wherein said associating entity profile data comprises:
in response to a second select signal received proximate the first table entry, displaying an interface object containing at least one selectable element including a first selectable element that displays a relation ID that indicates a correlation of the at least one other system entity with respect to the first system entity;
in response to selection of the first selectable element, displaying a second table object comprising multiple table entries that are each mapped to a respective one of multiple columnar fields and a respective one of multiple row records, wherein the columnar fields include a system entity identifier (ID) field, a metric identifier field, and multiple timestamp value fields; and
in response to a first select signal received proximate to one or more of the row records within the second table object, displaying, within a second window object, time series metric data corresponding to each of one or more system entities that are each associated with a system entity ID specified by the system entity ID field of the selected one or more row records.

8. One or more non-transitory machine-readable storage media comprising program code for displaying time series metric data, the program code to:
generate time series metric data that include, metric values associated with system entities; and
a timestamp associated with each of the metric values;
display the time series metric data in a first table object comprising multiple table entries that are each mapped to a respective one of multiple columnar fields and a respective one of multiple row records, wherein the columnar fields include a system entity identifier (ID) field, a metric identifier field, and multiple timestamp value fields; and
in response to a first select signal received proximate to one or more of the row records, display, within a first window object, time series metric data corresponding to one or more system entities that are each associated with a system entity ID specified by the system entity ID field of the selected one or more row records.

9. The machine-readable storage media of claim 8, wherein the program code to display the time series metric data in the first table object comprises program code to:
within each row record of the first table object, display a system entity ID entry in association with a metric ID entry; and
display an operational metric value within each columnar entry of the timestamp value fields.

10. The machine-readable storage media of claim 9, wherein the program code to display time series metric data within the first window object comprises program code to display the time series metric data as points in a two-dimensional graph that includes a first axis corresponding to a range of metric values and a second axis corresponding to a time range.

11. The machine-readable storage media of claim 8, further comprising program code to:
in response to the first select signal received proximate to a first row record of the first table object, determine a data path association between a first metric specified in the metric ID field of the first row record and a second metric specified in the metric ID field of a second row record; and
wherein said displaying time series metric data within the first window object comprises, in response to determining the data path association, displaying time series representations of the first metric and the second metric as points in a two-dimensional graph that includes a first axis corresponding to a range of metric values and a second axis corresponding to a time range.

12. The machine-readable storage media of claim 11, further comprising program code to:
display, within the first table object, a highlight indicator associated with the first row record; and
in response to determining the data path association, display a highlight indicator associated with a second row record that specifies the second metric.

13. The machine-readable storage media of claim 8, further comprising program code to:
associate entity profile data with a first table entry within a first row record of the one or more selected row records, wherein the first table entry is within a columnar field that displays a system entity ID, and wherein the entity profile data includes,
profile data for a first system entity corresponding to the system entity ID entry included in the first row record; and
profile data for at least one other system entity.

14. The machine-readable storage media of claim 13, wherein the program code to associate entity profile data comprises program code to:
in response to a second select signal received proximate the first table entry, display an interface object containing at least one selectable element including a first selectable element that displays a relation ID that indicates a correlation of the at least one other system entity with respect to the first system entity;
in response to selection of the first selectable element, display a second table object comprising multiple table entries that are each mapped to a respective one of multiple columnar fields and a respective one of multiple row records, wherein the columnar fields include a system entity identifier (ID) field, a metric identifier field, and multiple timestamp value fields; and
in response to a first select signal received proximate to one or more of the row records within the second table object, display, within a second window object, time series metric data corresponding to each of one or more system entities that are each associated with a system entity ID specified by the system entity ID field of the selected one or more row records.

15. An apparatus comprising:
a processor; and
a machine-readable medium having program code executable by the processor to cause the apparatus to,
generate time series metric data that include,
metric values associated with system entities; and
a timestamp associated with each of the metric values;
display the time series metric data in a first table object comprising multiple table entries that are each mapped to a respective one of multiple columnar fields and a respective one of multiple row records, wherein the columnar fields include a system entity identifier (ID) field, a metric identifier field, and multiple timestamp value fields; and
in response to a first select signal received proximate to one or more of the row records, display, within a first window object, time series metric data corresponding to one or more system entities that are each associated with a system entity ID specified by the system entity ID field of the selected one or more row records.

16. The apparatus of claim 15, wherein the program code further comprises program code executable by the processor to cause the apparatus to:
within each row record of the first table object, display a system entity ID entry in association with a metric ID entry; and
display an operational metric value within each columnar entry of the timestamp value fields.

17. The apparatus of claim 16, wherein the program code further comprises program code executable by the processor to cause the apparatus to display the time series metric data as points in a two-dimensional graph that includes a first axis corresponding to a range of metric values and a second axis corresponding to a time range.

18. The apparatus of claim 15, wherein the program code further comprises program code executable by the processor to cause the apparatus to:
in response to the first select signal received proximate to a first row record of the first table object, determine a data path association between a first metric specified in the metric ID field of the first row record and a second metric specified in the metric ID field of a second row record; and
wherein said displaying time series metric data within the first window object comprises, in response to determining the data path association, displaying time series representations of the first metric and the second metric as points in a two-dimensional graph that includes a first axis corresponding to a range of metric values and a second axis corresponding to a time range.

19. The apparatus of claim 18, wherein the program code further comprises program code executable by the processor to cause the apparatus to:
display, within the first table object, a highlight indicator associated with the first row record; and
in response to determining the data path association, display a highlight indicator associated with a second row record that specifies the second metric.

20. The apparatus of claim 15, wherein the program code further comprises program code executable by the processor to cause the apparatus to:
associate entity profile data with a first table entry within a first row record of the one or more selected row records, wherein the first table entry is within a columnar field that displays a system entity ID, and wherein the entity profile data includes,
profile data for a first system entity corresponding to the system entity ID entry included in the first row record; and
profile data for at least one other system entity; and
wherein the program code executable by the processor to cause the apparatus to associated entity profile data with the first table entry further comprises program code executable by the processor to cause the apparatus to:
in response to a second select signal received proximate the first table entry, display an interface object containing at least one selectable element including a first selectable element that displays a relation ID that indicates a correlation of the at least one other system entity with respect to the first system entity;
in response to selection of the first selectable element, display a second table object comprising multiple table entries that are each mapped to a respective one of multiple columnar fields and a respective one of multiple row records, wherein the columnar fields include a system entity identifier (ID) field, a metric identifier field, and multiple timestamp value fields; and
in response to a first select signal received proximate to one or more of the row records within the second table object, display, within a second window object, time series metric data corresponding to each of one or more system entities that are each associated with a system entity ID specified by the system entity ID field of the selected one or more row records.
